(19) United States
(12) Patent Application Publication
(10) Pub. No.: US 2006/0203473 A1
(43) Pub. Date: Sep. 14, 2006

(54) Portable illuminator with mirror

(76) Inventor: Chih-Yuan Hsueh, Tauyuan Hsien (TW)

Correspondence Address: Hsueh, Chih-Yuan, 9F., No. 37, Dongsing Road, Xinyi District, Taipei City, 110, TW

(21) Appl. No.: 11/078,879

(22) Filed: Mar. 14, 2005

(51) Int. Cl. F21V 33/00

(52) U.S. Cl. 362/135

(57) ABSTRACT

A portable illuminator with mirror includes a receiving box formed from a lower case and an inner cover closed to an open top of the lower case, an upper case pivotally connected to one side of the receiving box and having a mirror attached to an inner side thereof, and a circuit board mounted in the receiving box. The circuit board is provided at two opposite ends with a battery seat and an external light source, respectively, and at a middle section with at least one internal light source corresponding to a light-pervious sheet mounted in an opening on the inner cover. Batteries mounted in the battery seat supply power needed by the internal and the external light source to illuminate the mirror on the upper case and project light like a flashlight, respectively.

### FIELD OF THE INVENTION

The present invention relates to a portable illuminator with mirror, and more particularly to a portable illuminator with mirror that not only functions like a flashlight, but also allows a user to conveniently use the mirror thereof to, for example, touch up her make-up even if in a dim environment.

### BACKGROUND OF THE INVENTION

Social etiquette is important in modern society for people to maintain good human relations. A person with good social etiquette not only has respect for others, but also shows good self-discipline and excellent taste in things. For female, timely touching up of her make-up is an important social etiquette. For this purpose, most women attending a formal social activity would carry a small dressing mirror about for use at any time. Such small dressing mirror is normally attached to a cover of a compact, and provides only a very limited viewing area due to its small size.

There is also a box for receiving different cosmetics, such as eyebrow pencil, lipstick, etc., and having a relatively big mirror attached to an inner side of a cover thereof to provide better viewing effect. However, the mirror is frequently changed in position and inconvenient for use when a user opens the box to take out the cosmetics from the box.

Another disadvantage of most conventional compacts and cosmetic boxes with mirror is that they do not have any illuminating means and are therefore not suitable for use in a dim environment.

It is therefore tried by the inventor to develop a portable illuminator with mirror to eliminate the drawbacks existed in the conventional compacts or cosmetic boxes.

### SUMMARY OF THE INVENTION

A primary object of the present invention is to provide a portable illuminator with mirror that not only functions like a flashlight, but also allows a user to conveniently use its mirror at any time.

Another object of the present invention is to provide a portable illuminator with mirror that not only functions like a flashlight, but also allows a user to conveniently use its mirror in a dim environment.

To achieve the above first object, the portable illuminator with mirror according to the present invention mainly includes a receiving box formed from a lower case and an inner cover closed to an open top of the lower case, an upper case pivotally connected to one side of the receiving box and having a mirror attached to an inner side thereof, and a circuit board mounted in the receiving box. The circuit board is provided at two opposite ends with a battery seat and an external light source, respectively. Batteries mounted in the battery seat supply power needed by the external light source to project light for the illuminator to function like a flashlight, and the upper case may be opened to expose the mirror for use at any time.

To achieve the second object, the circuit board of the portable illuminator with mirror according to the present invention further includes at least one internal light source, and the inner cover of the receiving box is provided at a position corresponding to the at least one internal light source with an opening, in which a light-pervious sheet is mounted. Batteries mounted in the battery seat also supply power needed by the at least one internal light source to project light through the light-pervious sheet and illuminate the mirror on the upper case, enabling a user to use the mirror even if in a dim environment.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of a portable illuminator with mirror according to an embodiment of the present invention;

FIG. 2 is an assembled phantom view of the portable illuminator with mirror FIG. 1;

FIG. 3 is an assembled perspective view of the portable illuminator of FIG. 1 with an upper case thereof in an open position;

FIG. 4 is an assembled perspective view of the portable illuminator of FIG. 1 with the upper case thereof in a closed position;

FIG. 5 shows a user may conveniently open the portable illuminator of the present invention to use the mirror thereof; and

FIG. 6 shows the portable illuminator of the present invention is closed to function like a flashlight.

### DETAILED DESCRIPTION OF THE PREFERRED EMBODIMENTS

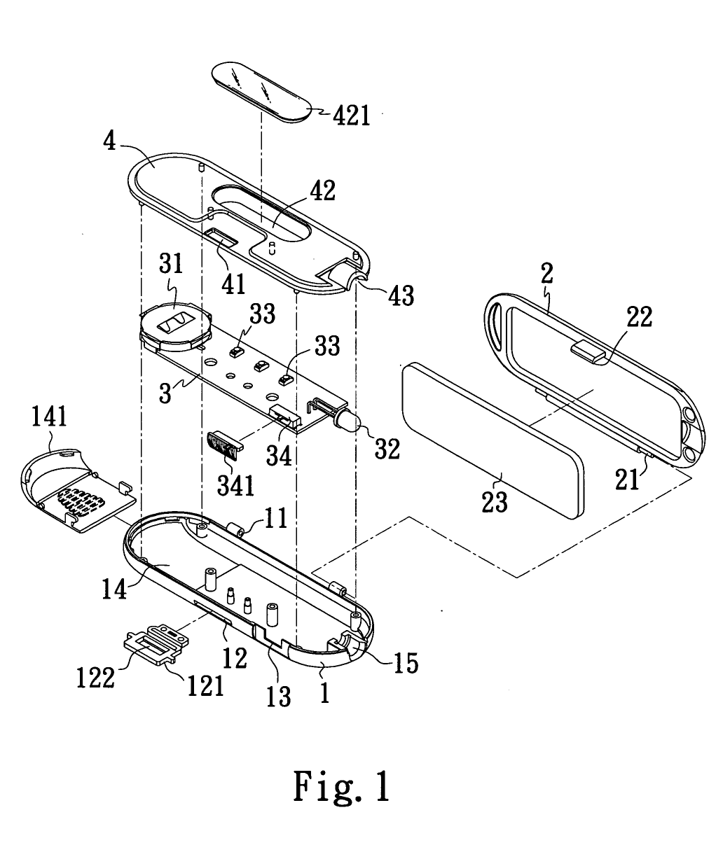

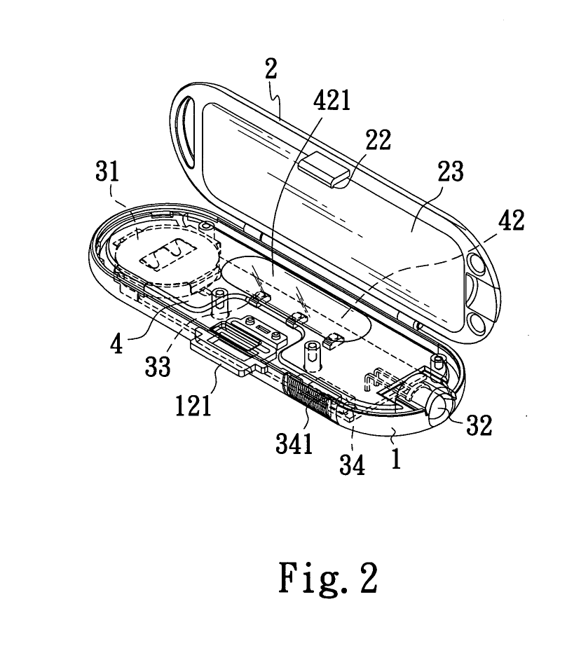

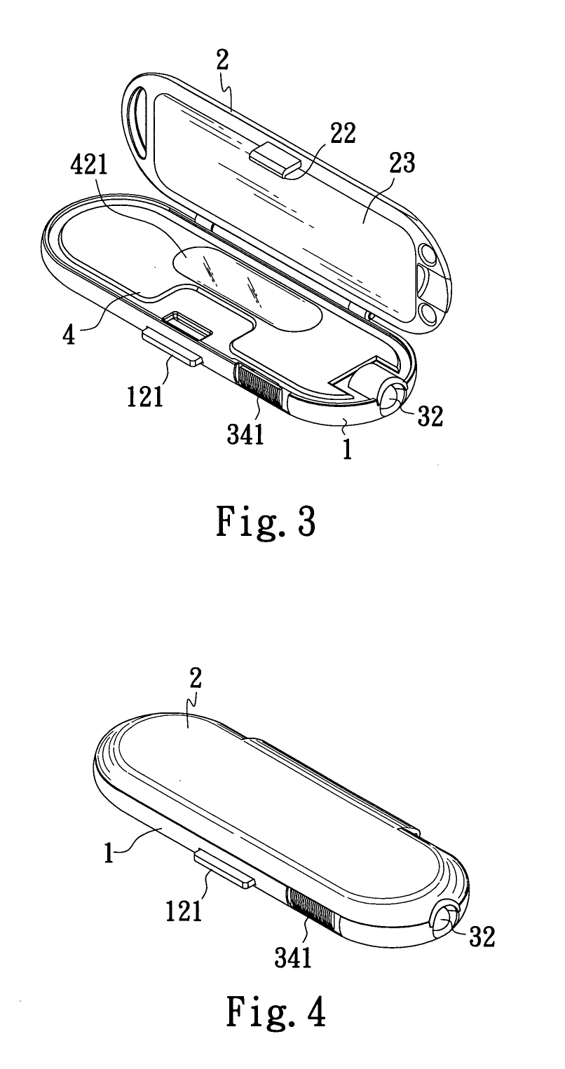

Please refer to FIGS. 1 and 2 that are exploded and assembled phantom views, respectively, of a portable illuminator with mirror according to an embodiment of the present invention, and to FIGS. 3 and 4 that are two assembled perspective views of the portable illuminator of the present invention with an upper case thereof in an open and a closed position, respectively. As shown, the portable illuminator with mirror of the present invention mainly includes a lower case 1, an upper case 2, a circuit board 3, and an inner cover 4.

The lower case 1 is provided at one lateral side with a plurality of spaced joints 11, at the other opposite lateral side with a slot 12, at a front end with an open-topped recess 15, and between the slot 12 and the recess 15 with a notch 13. A rear bottom of the lower case 1 opposite to the recess 15 is an opening 14, to which a battery cover 141 is removably closed. A push key 121 is inward movably set in the slot 12.

The upper case 2 is a cover defining at an inner central area a flat recess for a mirror 23 to fitly attach thereto. The upper case 2 is provided at one lateral side with a plurality of pivot pins 21 corresponding to the joints 11 on the lower case 1 for extending into and pivotally turnably engaging with the joints 11, and at the other opposite lateral side with a catch 22 corresponding to the slot 12 on the lower case 1 for extending into and engaging with a retaining hole 122 on the push key 121 and thereby holding the upper case 2 to the lower case 1.

The circuit board 3 is mounted in the lower case 1, and provided at a rear end with a battery seat 31 corresponding to the opening 14 and the battery cover 141, at a front end with an external light source 32 corresponding to the open-topped recess 15 on the lower case 1, at one lateral side with a plurality of internal light sources 33, and at the other opposite lateral side with a slide switch 34 corresponding to the notch 13 on the lower case 1.

The inner cover 4 is located above the circuit board 3 and locked to the lower case 1. The inner cover 4 is provided at a front end with an open-bottomed recess 43 corresponding to the external light source 32 and the open-topped recess 15, at one lateral side with a long opening 42 corresponding to the internal light sources 33 on the circuit board 3, and at the other opposite lateral side with a through hole 41 corresponding to the slot 12 on the lower case 1. A light-pervious sheet 421 is mounted in the long opening 42.

In assembling the portable illuminator of the present invention, the open-bottomed recess 43 on the inner cover 4 is aligned with the open-topped recess 15 on the lower case 1, so that a sleeve with a front open end is formed around the external light source 32 on the circuit board 3; and a sliding member 341 is connected to an outer side of the slide switch 34 for moving the slide switch 34 forward or rearward. The battery cover 141 is removable from the bottom opening 14 of the lower case 1 for installing batteries in the battery seat 31 on the circuit board 3 to supply power needed by the external and the internal light sources 32, 33. When the upper case 2 is closed onto the lower case 1, the catch 22 downward extends through the through hole 41 on the inner cover 4 to engage with the retaining hole 122 on the push key 121, which is fixed in the slot 12 of the lower case 1, and thereby firmly holds the upper case 2 to the lower case 1. And, when the push key 121 is inward pushed, the retaining hole 122 is shifted inward at the same time to disengage from the catch 22, so that the upper case 2 is released from the lower case 1 and can be opened.

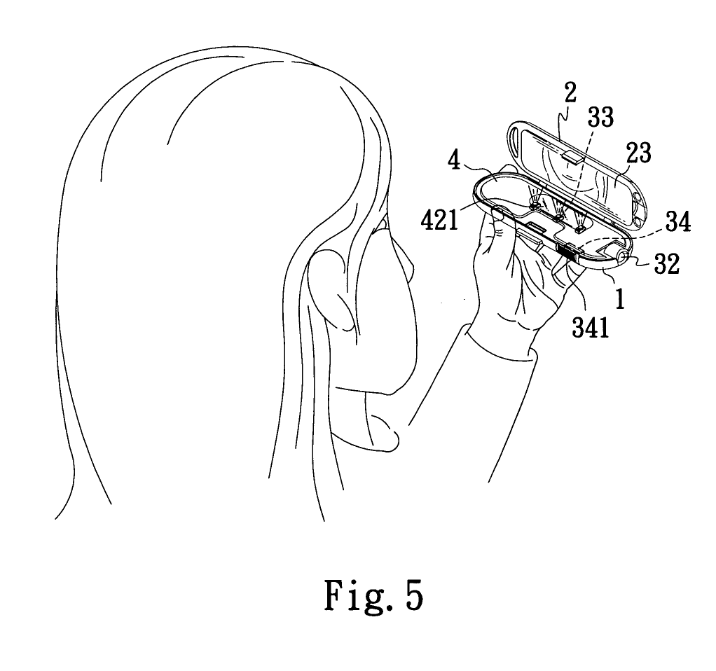

As can be seen from FIG. 5, when the upper case 2 of the portable illuminator of the present invention is opened to expose the mirror 23 attached to the inner central recess of the upper case 2, a user may use the mirror 23 to examine and touch up her make-up when necessary. In the event of a dim environment, the sliding member 341 may be moved to actuate the slide switch 34 and thereby turn on the internal light sources 33, which may be, for example, small-sized light emitting diodes. Light emitted from the internal light sources 33 and projected on the light-pervious sheet 421 diffuses to provide necessary illuminance for viewing the mirror 23.

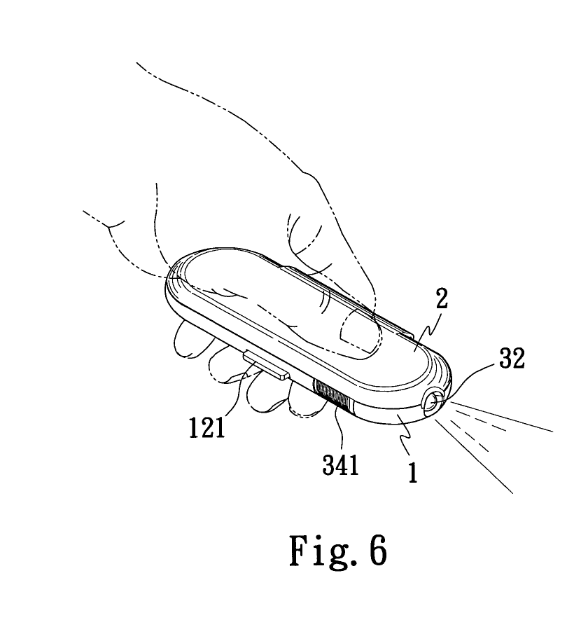

FIG. 6 shows the use of the present invention as a flashlight. When the upper case 2 is closed onto the lower case 1 with the mirror 23 invisibly located between the upper case 2 and the inner cover 4, and the sliding member 341 is moved reversely to actuate the slide switch 34 and thereby turn on the external light source 32, which may be, for example, a large-sized light emitting diode or a small-sized bulb, light emitted from the external light source 32 diffuses to illuminate surrounding areas.

Therefore, the portable illuminator with mirror according to the present invention not only functions as a flashlight, but also allows a user to use the mirror even if in a dim environment, and is therefore a novel, improved, and industrially useful product.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A portable illuminator with mirror, comprising:
a receiving box formed from a lower case and an inner cover fitted to an open top of said lower case, said inner cover being provided at a middle section with a long opening, in which a light-pervious sheet is mounted;
an upper case pivotally turnably connected to one lateral side of said receiving box, and having a mirror attached to an inner side thereof; and
a circuit board mounted in said receiving box between said lower case and said inner cover, and including a battery seat and an external light source provided at two opposite ends thereof; said circuit board also including at least one internal light source corresponding to said long opening on said inner cover, and a slide switch for controlling batteries mounted in said battery seat to supply power needed by said internal and said external light source.

2. The portable illuminator with mirror as claimed in claim 1, wherein said upper case is provided at a middle section of a movable side opposite to said lateral side pivotally connected to said lower case with a perpendicularly protruded catch, which downward extends through a through hole on said inner cover to engage with a retaining hole on a push key mounted on said lower case when said upper case is pivotally turned to close onto said lower case; whereby when said push key is inward pushed relative to said lower case and thereby shifts said retaining hole inward to disengage from said catch, said upper case can be opened.

3. The portable illuminator with mirror as claimed in claim 1, wherein said slide switch is connected to a sliding member, which is located at an outer side of said lower case.

4. The portable illuminator with mirror as claimed in claim 1, wherein said lower case and said inner cover are provided at an end corresponding to said external light source on said circuit board with an open-topped and an open-bottomed recess, respectively.

5. The portable illuminator with mirror as claimed in claim 1, wherein said lower case is provided at an area corresponding to said battery seat on said inner cover with an opening, to which a battery cover is removably mounted to normally close said opening.
